(19) United States
(12) Patent Application Publication
(10) Pub. No.: US 2005/0081198 A1
(43) Pub. Date: Apr. 14, 2005

(54) System and method for limiting software installation on different computers and associated computer-readable storage media

(76) Inventors: Sinkuo Cho, Fremont, CA (US); Yu-Wen Huang, Taipei City (TW); Hsin-Wen Su, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/948,160

(22) Filed: Sep. 24, 2004

(30) Foreign Application Priority Data
Sep. 25, 2003 (TW) 092126528

(51) Int. Cl. G06F 3/00

(52) U.S. Cl. 717/174; 713/150

(57) ABSTRACT

A method for limiting the number of times that software can be installed on different computers is provided. The method is suitable for PC with disk ROMs. With the USB flash drive connected to PC, the method includes the steps of: (a) the CD in the Disk ROM starting the software installation process; (b) the installation process requesting a hardware identification from the PC; (c) comparing the hardware identification of USB flash drive to determine if continuing the software installation process; (d) decoding the identification file in the USB flash drive; (e) checking if the hardware identification being already stored in decoded identification file; and (f) determining if finishing the software installation process in response to the checking step.

### BACKGROUND OF THE INVENTION

1. Field of the Invention

The present invention relates to a system and a method for limiting the software installation on different computers and associated storage media and, more particularly, to a system and a method for utilizing a universal serial bus (USB) flash disk to limit the software installation on different computers and associated computer-readable storage media.

2. The Related Art

The operation system (OS) for personal computers (PCs) has evolved from Windows 3.1, Windows 95, Windows 98, Windows NT, to the recent Windows 2000 and Windows XP. The installation process of OS is usually long and tedious for the users. On the other hand, the OS providers are also troubled by the unauthorized copy or piracy.

The universal serial bus (USB) is becoming popular in recent years. The current USB standard includes USB1.1 and USB 2.0. USB1.1 supports low speed peripherals and full speed peripherals. The low speed transmission specification has the transmission speed of 1.5 Mbps and tolerance of error 1.5%. The full speed transmission specification has the transmission speed of 12 Mbps and tolerance of error 0.25%. USB2.0 supports high speed peripherals, and the transmission speed can be as high as 480 Mbps. The low speed peripherals include USB keyboard, USB mouse, USB joystick, and so on. The full speed peripherals include USB flash drive, USB printer, USB scanner, and so on. The current USB2.0 standard is downward compatible to USB1.1. That is, USB2.0 supports low speed, full speed and high speed peripherals.

### SUMMARY OF THE INVENTION

The present invention provides a method for limiting the number of times a software can be installed on different computers. The method is suitable for PC with a disk ROM. With the USB flash drive connected to PC, the method includes the steps of: (a) the CD in the disk ROM starting the software installation process; (b) the installation process requesting a hardware identification from the PC; (c) comparing the hardware identification of USB flash drive to determine if continuing the software installation process; (d) decoding the identification file in the USB flash drive; (e) checking if the hardware identification being already stored in decoded identification file; and (f) determining if finishing the software installation process in response to the checking step.

The present invention also provides a method for limiting the number of times a software can be installed on different computers. The method is suitable for PC with a disk ROM. With the USB flash drive connected to PC, the method includes the steps of: (a) using the image file in the CD to boot the PC; (b) the CD starting installing the OS to the PC; (c) requesting a hardware identification from the PC; (d) comparing the hardware identification of USB flash drive to determine if continuing the software installation process; (e) decoding the identification file in the USB flash drive; (f) checking if the hardware identification being already stored in decoded identification file, when the number of the times the OS being installed being less than the predetermined limit, encoding and adding the hardware identification to the identification file; and (g) determining if finishing the OS installation process in response to the checking step.

The present invention further provides a computer system, including a central processing unit (CPU), a chip set, a disk ROM, and a USB port. The chip set is coupled to the CPU. The disk ROM and the USB port are coupled to the chip set. The disk ROM is for reading the CD, and the USB port is coupled to the USB flash drive. The computer system uses the disk ROM to read the CD and starts the software installation process. The installation process requests at least a hardware identification from the computer system. The computer system decodes the identification file in the USB flash drive and determines if the installation process should be finished by checking whether the hardware identification is already stored in the decoded identification file.

The present invention further provides a storage medium accessible to computers. The storage medium includes a hidden partition for storing software installation key and identification file; and a plurality of storage partitions for storing information by using software installation key and identification file to determine if finishing the software installation process. Preferably, the storage medium is the flash memory of a USB flash drive.

The present invention provides an optical storage medium accessible to computers. The storage medium includes a boot image means for booting the computers; and an OS installation means for reading the installation key and the identification file on the USB flash drive. The OS installation means requests a hardware identification from the computer. The computer uses the installation key and the identification file to determine if the OS installation should be performed.

These and other objects, features and advantages of the invention will be apparent to those skilled in the art, from a reading of the following brief description of the drawings, the detailed description of the preferred embodiment, and the appended claims.

### BRIEF DESCRIPTION OF THE DRAWINGS

FIG. 1 shows a flowchart of a method for limiting the software installation times according to one embodiment of the present invention.

FIG. 2 shows a flowchart of a method for limiting the software installation times according to another embodiment of the present invention.

### DETAILED DESCRIPTION OF THE PREFERRED EMBODIMENT AND THE

### BEST MODE FOR CARRYING THE INVENTION

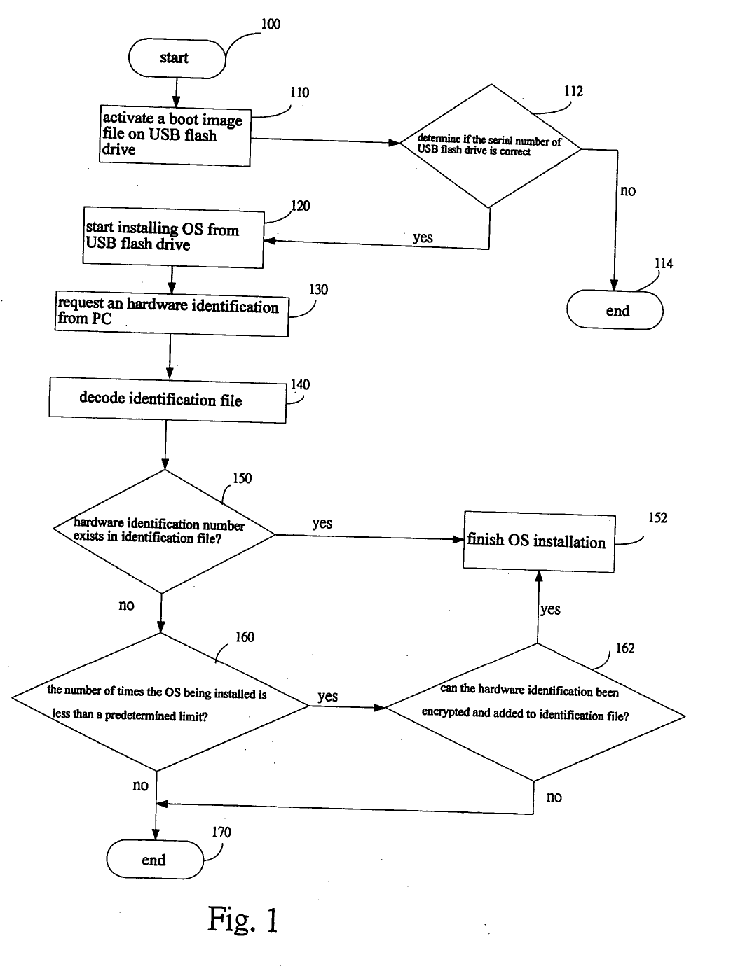

FIG. 1 shows a flowchart of a method for limiting the number of times that software can be installed on different computers. The flowchart starts with step 100, wherein OS installation program is stored in a USB flash drive and a brand new PC has not installed software in this embodiment. The BIOS of PC is set to use USB flash drive as the default boot disk. When the PC is powered up, in step 110, the PC activates the boot image file on the USB flash drive to start the boot process and automatically executes a serial number matching program to determine if the current OS installation program is on the correct USB flash drive. By reading the unique serial number on the USB flash drive, the serial number is compared with the correct serial number for the USB flash drive stored in the boot image file. Preferably, the serial number is encrypted while stored in boot image file. If the comparison shows that the OS installation program is not on the correct USB flash drive, proceed to step 114 and terminate the OS installation process to prevent unauthorized duplication of the contents in the USB flash drive.

On the other hand, if the comparison shows that the OS installation program is on the correct USB flash drive, proceed to step 120. In step 120, USB flash drive starts installing the OS to the PC. Step 130 is to request a hardware identification from the PC. The hardware identification preferably includes a boot hard disk serial number, a network card serial number, a CPU serial number, and so on, or combinations thereof. Step 140 is to decode an identification file in the USB flash drive. Step 150 is to check if the hardware identification from the PC exists in the identification file. If the hardware identification from the PC exists in the identification file, it indicates that the OS stored in the USB flash drive has been installed on the PC before, and the PC is authorized for the installation. In this case, proceed to step 152 to finish the OS installation. Otherwise, proceed to step 160 to determine if the number of times that the OS in the USB flash drive has been installed on different computers exceeds the predetermined authorized limit. If the limit is not exceeded, the flowchart proceeds to step 162 to further determine if the hardware identification can be added to the decoded identification file. If so, add the hardware identification to the identification file and branch to step 152 to finish the installation. Otherwise, proceed to step 170 to terminate the installation. This allows the user to re-install the OS as well as the OS provider to limit the distribution of the OS.

FIG. 1 embodies a USB flash drive as an example. Alternatively, a re-writable CD on a PC having a CD burner can be applied in a similar way. Alternatively, a re-writable DVD on a PC with a DVD burner can also be applied. Therefore, aforementioned embodiment is applicable to a variety of storage media.

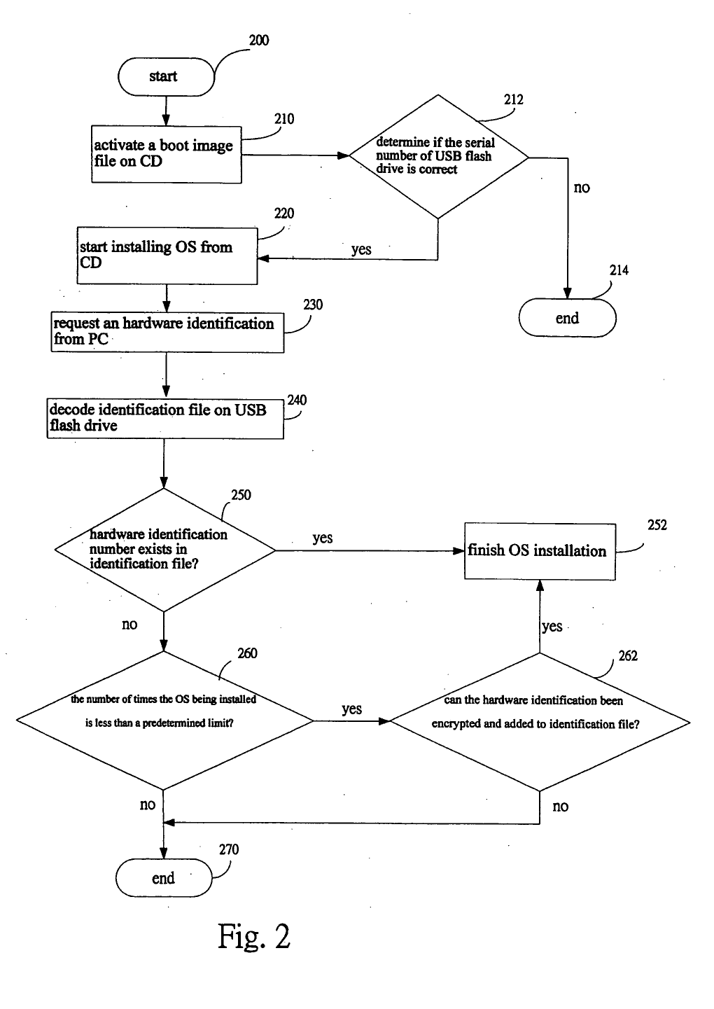

FIG. 2 shows another flowchart according to another embodiment of the present invention. Starting with step 200, the OS installation program is stored in a red-only CD and a USB flash drive acts as an installation key. A brand new PC without any installed software is used as an example. The BIOS of PC is set to boot from the CD/DVD ROM. When the PC is powered up, in step 210, the PC activates the boot image file on the CD to start the boot process and automatically executes a serial number matching program to determine if the correct USB flash drive is connected to the PC. By reading the unique serial number on the USB flash drive, the serial number is compared with the correct serial number for the USB flash drive stored in the boot image file on the CD, which is preferably encrypted. Preferably, the serial number is stored in the hidden partition or the card information structure (CIS) area in the USB flash drive. If the comparison shows that the connected USB flash drive is not the correct USB flash drive, proceed to step 214 and terminate the OS installation process to prevent unauthorized duplication of the contents in the read-only CD.

The hardware structure of a USB flash drive allows the hidden partition. For example, the USB flash drive includes one or more flash memory chips, each of which is accessed by blocks. As the capacity of the memory chip increases and the manufacturing process varies, some faulty blocks exist. The redundancy area of the faulty blocks will be marked. For example, a manufacturer may guarantee that a 1024-block flash memory will include 1003 functional blocks. As 1003 in this example is a lower bound, it possibly has 1008 functional blocks. However, as the USB controller is designed in accordance with the lower bound, namely 1003 blocks, the present invention requires the manufacturer to generate a hidden partition which is not included in the 1003 functional blocks. Alternatively, the CIS area can be used to store the installation key and associated information without affecting the other operations.

On the other hand, if the comparison result shows that the USB flash drive is the correct one, proceed to step 220. In step 220, the CD starts installing the OS to the PC. Step 230 is to request a hardware identification from the PC. The hardware identification preferably includes a boot hard disk serial number, a network card serial number, a CPU serial number, and so on, or combinations thereof. Step 240 is to decode an identification file on the USB flash drive. Preferably the identification file is stored in the hidden partition or the CIS area of the USB flash drive. Step 250 is to check whether the hardware identification from the PC exists in the identification file or not. If the hardware identification from the PC exists in the identification file, it indicates that the OS stored in the USB flash drive has been installed on the PC before, and the PC is authorized for the installation. Then, proceed to step 252 to finish the OS installation. Otherwise, proceed to step 260 to determine if the number of times that the OS in the CD has been installed on different computers exceeds the predetermined authorized limit. If the recorded number does not exceed the predetermined authorized limit, the installation proceeds to step 262 to further determine if the hardware identification can be added to the decoded identification file. If so, add the hardware identification to the identification file and proceed to step 252 to finish the installation. Otherwise, proceed to step 270 to terminate the installation. This allows the user to re-install the OS as well as the OS provider to limit the distribution of the OS.

It should be noted that FIG. 2 embodies OS installation as an example. The CD in this embodiment can record any other type of software for installation. The read-only CD is low cost and free of virus infection. The present invention uses a USB flash drive as an installation key. The USB flash drive is easily portable and a single USB flash drive can be used as the installation key for a plurality of software and operation systems. The user only requires a single USB flash drive to install a plurality of authorized software. Preferably, the installation key is hidden in the hidden partition of the USB flash drive, which is inaccessible to the user and prevents information sabotage. Also, the hidden partition does not affect the normal USB flash drive operations performed by the user, such as accessing files and playing music. On the other hand, the two aforementioned embodiments both set the BIOS of the PC to use Disk ROM for booting, which is for installing operating system. If the present invention is applied in general software installation, the manufacturer can modify the automatic installation program.

Furthermore, the present invention discloses a concept that allows the user to duplicate the CD. However, the user cannot install the duplicate software without the appropriate authorization. The software provider can easily conduct the transaction through Internet or conventional channel, and then authorize the installation by assigning the number of times to the user's appointed USB flash drive through Internet. In addition, the user can download a specific software installation program to identify the appointed USB flash drive and the number of installation times. For the user, it is more convenient to use as it does not require the input of a CD key during the installation process, which is problematic when the CD key on the package is lost. Also, this alleviates the problem that the CD may need to contain a mechanism to prevent duplication. This may cause problem for the user as the user can no longer keep a back-up copy in case of the original copy is damaged. The USB controller providers can provide specific commands to allow the installation program in the CD to issue these specific access commands to the USB flash drive through the OS. These commands can access the hidden partition or the CIS area in the USB controller and perform the authorization. The software provider can also bundle a USB flash drive and an installation program when selling the software. The accompanying USB is required for installing the software, but it can also be used as a convenient storage for other information.

In summary, the present invention provides a method for limiting the number of times a software can be installed on different computers. The method is suitable for PC with Disk ROMs. With a USB flash drive connected to PC, the method includes the steps of: (a) the CD in the Disk ROM starting the software installation process; (b) the installation process requesting a hardware identification from the PC; (c) comparing the hardware identification of USB flash drive to determine if continuing the software installation process; (d) decoding the identification file in the USB flash drive; (e) checking if the hardware identification being already stored in decoded identification file; and (f) determining if finishing the software installation process in response to the checking step.

The present invention also provides a method for limiting the number of times a software can be installed on different computers. The method is suitable for PC with Disk ROMs. With the USB flash drive connected to PC, the method includes the steps of: (a) using the image file in the CD to boot the PC; (b) the CD starting installing the OS to the PC; (c) requesting a hardware identification from the PC; (d) comparing the hardware identification of USB flash drive to determine if continuing the software installation process; (e) decoding the identification file in the USB flash drive; (f) checking if the hardware identification being already stored in decoded identification file, when the number of the times the OS being installed being less than the predetermined limit, encoding and adding the hardware identification to the identification file; and (g) determining if finishing the OS installation process in response to the checking step.

The present invention further provides a computer system, including a central processing unit (CPU), a chip set, a Disk ROM, and a USB port. The chip set is coupled to the CPU. The Disk ROM and the USB port are coupled to the chip set. The Disk ROM is for reading the CD, and the USB port is coupled to the USB flash drive. The computer system uses the Disk ROM to read the CD and starts the software installation process. The installation process requests at least a hardware identification from the computer system. The computer system decodes the identification file in the USB flash drive and determines if the installation process should be finished by checking whether the hardware identification is already stored in the decoded identification file.

The present invention further provides a storage medium accessible to computers. The storage medium includes a hidden partition for storing software installation key and identification file; and a plurality of storage partitions for storing information by using software installation key and identification file to determine if finishing the software installation process. Preferably, the storage medium is the flash memory of a USB flash drive.

The present invention provides an optical storage medium accessible to computers. The storage medium includes a boot image means for booting the computers; and an OS installation means for reading the installation key and the identification file on the USB flash drive. The OS installation means requests a hardware identification from the computer. The computer uses the installation key and the identification file to determine if the OS installation should be performed.

While the invention has been described in connection with what is presently considered to the most practical and preferred embodiment and the best modes thereof, it is to be understood that the invention is not to be limited to the disclosed embodiment, but on the contrary, is intended to cover various modifications and equivalent arrangement included within the spirit and scope of the appended claims.

1. A method for limiting a number of times that software is installed on a computer, said computer having a disk ROM and connected to a flash drive, said method comprising the following steps:
(a) a CD in said disk ROM starting a software installation process;
(b) said installation process requesting a hardware identification from said computer;
(c) decoding an identification file in said flash drive;
(d) checking if said hardware identification being already stored in said decoded identification file; and
(e) determining if finishing said software installation process in response to said checking step (c).

2. The method as claimed in claim 1 further comprising a step of comparing a hardware serial number of said flash drive to determine if continuing said installation process.

3. The method as claimed in claim 1 further comprising a step of encrypting and adding said hardware identification to said decoded identification file when said checking step indicating that the number of said software being installed less than a predetermined limit.

4. The method as claimed in claim 1, wherein said flash drive is a USB flash drive.

5. A method for limiting the number of times that an operating system (OS) is installed on different computers, said computers having a disk ROM and connected to a flash drive, said method comprising the steps of:
(a) using an image file in a CD in said disk ROM to boot said computer;
(b) said CD starting installing said OS to said computer PC;
(c) requesting a hardware identification from said computer;
(d) decoding an identification file in said flash drive;
(e) checking if said hardware identification being already stored in said decoded identification file; and
(f) determining if finishing said OS installation in response to said checking step.

6. The method as claimed in claim 5 further comprising flash drive step of comparing a hardware serial number of said flash drive to determine if continuing said installation process.

7. The method as claimed in claim 5 further comprising a step of encrypting and adding said hardware identification to said decoded identification file when said checking step indicating that the number of said software being installed less than a predetermined limit.

8. The method as claimed in claim 5, wherein said flash drive is a USB flash drive.

9. A computer readable storage medium, comprising:
a hidden partition for storing a software installation key and an identification file; and
a storage partition for storing information;
wherein said software installation key and said identification file being used to determine if a software installation process should be finished.

10. The storage medium as claimed in claim 9, wherein said storage medium is a flash memory in a USB flash drive.

11. The storage medium as claimed in claim 10, wherein an installation program of said software is stored in a read-only CD.

12. The storage medium as claimed in claim 10, wherein said identification file is for recording a plurality of hardware identifications.

13. The storage medium as claimed in claim 10, wherein said installation program of said software is stored in said storage partition.

14. The storage medium as claimed in claim 10, wherein said hidden partition is a CIS area.

15. A computer readable optical storage medium, comprising:
a boot image means for booting a computer; and
an OS installation means for reading an installation key and an identification file on a USB flash drive;
wherein said installation key and said identification file being used to determine if an OS installation should be performed.

16. The optical storage medium as claimed in claim 15, wherein said optical storage medium is a read-only CD.

17. The optical storage medium as claimed in claim 15, wherein said identification file is for storing a plurality of hardware identifications.

18. The optical storage medium as claimed in claim 15, wherein said OS installation means requests a hardware identification from a computer and said computer, based on said installation key and said identification file, determines if said OS should be installed.

19. A computer system, comprising:
a central processing unit;
a chip set coupled to said CPU;
a disk ROM coupled to said chip set for reading a CD; and
a USB port coupled to said chip set and a USB flash drive;
wherein said computer system using said CD to start a software installation process, said installation process requesting at least a hardware identification from said computer system, said computer system decoding an identification file in said USB flash drive and determining if said installation process should be finished by checking whether said hardware identification being already stored in said decoded identification file.

20. The system as claimed in claim 19, wherein said computer system determines if continuing said software installation process by comparing a hardware serial number of said USB flash drive.

21. The system as claimed in claim 19, wherein when said computer system determines said hardware identification does not exist in said decoded identification file and the number of times said software being installed on different computers is less than a preset limit, said hardware identification is added to said identification file.

22. The system as claimed in claim 19, wherein said software installation process is an OS installation process.
